(19) United States
(12) Patent Application Publication
(10) Pub. No.: US 2025/0269820 A1
(43) Pub. Date: Aug. 28, 2025

(54) ALARM CONTROL DEVICE

(71) Applicant: TOYOTA JIDOSHA KABUSHIKI KAISHA, Toyota-shi (JP)

(72) Inventor: Shinnosuke SUGAWARA, Toyota-shi (JP)

(73) Assignee: TOYOTA JIDOSHA KABUSHIKI KAISHA, Toyota-shi (JP)

(21) Appl. No.: 18/974,797

(22) Filed: Dec. 10, 2024

(30) Foreign Application Priority Data
Feb. 28, 2024 (JP) 2024-028600

(51) Int. Cl. B60R 25/10; B60R 25/24; B60R 25/30

(52) U.S. Cl. CPC B60R 25/1003; B60R 25/305; B60R 25/24

(57) ABSTRACT

The disclosure relates to an alarm control device. The alarm control device does not activate the alarm device when the door is unlocked without using the authenticated key from the interior of the vehicle while the alarm device is in the valid state and the authenticated key is in the interior of the vehicle.

### CROSS-REFERENCE TO RELATED APPLICATION

This application claims priority to Japanese Patent Application No. 2024-028600 filed on Feb. 28, 2024, incorporated herein by reference in its entirety.

### BACKGROUND

### 1. Technical Field

The present disclosure relates to an alarm control device.

### 2. Description of Related Art

Japanese Unexamined Patent Application Publication No. 61-237778 (JP 61-237778 A) describes an alarm control device that activates an alarm when a door of a vehicle is unlocked without using a remote key after the door is locked using the remote key.

### SUMMARY

The alarm control device described in JP 61-237778 A activates an alarm device even when the door of the vehicle is unlocked using a door key in a state in which a user of the vehicle possesses the remote key after the door of the vehicle is locked using the remote key.

An aspect of the present disclosure provides an alarm control device that controls an alarm device that activates an alarm when a door of a vehicle is unlocked, the alarm control device controlling the alarm device so as to shift to an activated state when the door is locked using an authenticated key, and so as to shift to an inactivated state when the door is unlocked using the authenticated key, in which
the alarm device is not caused to issue an alarm when the door is unlocked from an inside of a cabin of the vehicle without using the authenticated key in a state in which the alarm device is in the activated state and the authenticated key is in the inside of the cabin of the vehicle.

It is possible to issue an alarm in a preferable manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an electrical configuration of an alarm control device;

FIG. 2 is a flow chart showing a flow of an alarm control process at the time of unlocking; and

FIG. 3 is a flowchart illustrating a flow of unlocking method determination processing.

### DETAILED DESCRIPTION OF EMBODIMENTS

### First Embodiment

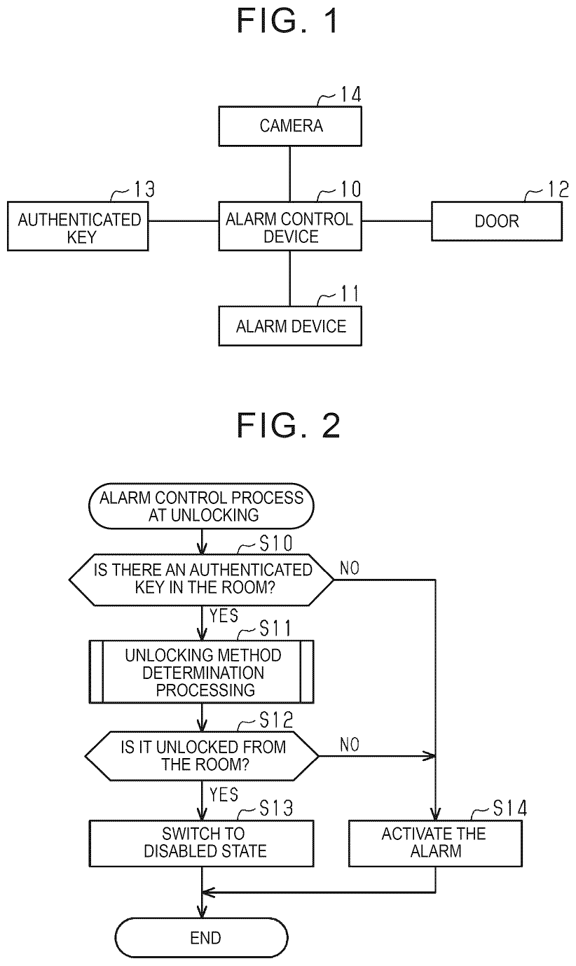

Hereinafter, a first embodiment of the alarm control device will be described with reference to FIGS. 1 to 3.

The alarm control device for controlling the alarm device includes a processor, a storage, and a memory. A program for controlling the alarm device is stored in the storage. The processor controls the alarm device by executing a program based on information stored in the memory.

### Electrical Configuration of Alarm Control Device

As shown in FIG. 1, the alarm control device 10 is electrically connected to the alarm device 11. The alarm device 11 is a device that activates an alarm. For example, the alarm is a buzzer ringing. The alarm device 11 may transition between a valid state in which an alarm can be activated and a disabled state in which an alarm cannot be activated. The alarm control device 10 can shift the alarm device 11 from the disabled state to the enabled state. The alarm control device 10 can shift the alarm device 11 from the enabled state to the disabled state. The alarm control device 10 can activate an alarm to the alarm device 11.

The alarm control device 10 is electrically connected to the door 12 of the vehicle. The alarm control device 10 can acquire, from the door 12, an opening amount signal capable of recognizing an opening amount of a window provided in the door 12. For example, the opening amount signal is output from the door 12 when the opening amount of the window of the door 12 changes. The window of the door 12 is opened and closed by a motor provided in the door 12. The motor of the door 12 is operated by operating an opening/closing switch provided in the door 12. The alarm control device 10 can acquire, from the door 12, a locking signal capable of recognizing whether or not the door 12 is locked. Locking and unlocking the door 12 is to lock and unlock the door lock provided on the door 12. In the present specification, when “unlock” is described, the door 12 is unlocked by a normal method. On the other hand, the phrase “unlocked” includes a state in which the door 12 is unlocked regardless of the proper method. The door 12 is locked and unlocked by operating a locking and unlocking switch provided in the door 12. For example, the locking and unlocking switch is provided in the door 12 so as to be operable from the interior of the vehicle. Locking and unlocking the door 12 by operating a locking and unlocking switch from the interior of the vehicle is to lock and unlock the door 12 by a regular method.

The alarm control device 10 is electrically connected to an authenticated key 13 for locking and unlocking the door 12. The authenticated key 13 is a key that has been authenticated by the verification control device provided in the vehicle. For example, the verification control device executes ID verification of the authenticated key 13 by a narrow-area radio (communication range: several meters). The authenticated key 13 can lock and unlock the door 12 by narrow-area radio. Locking and unlocking the door 12 using the authenticated key 13 is locking and unlocking the door 12 in a regular manner.

For example, the alarm control device 10 can acquire ID verification from the verification control device. The alarm control device 10 can identify the authenticated key 13 based on ID verification obtained from the verification control device. The alarm control device 10 can acquire the periodic signal by the narrow range radio from the authenticated key 13. For example, the authenticated key 13 outputs a periodic signal at every specified period. For example, the alarm control device 10 is configured to include an antenna for acquiring a signal by narrow-area radio from the authenticated key 13. For example, the alarm control device 10 can acquire a signal by narrow-area radio from the authenticated key 13 when the authenticated key 13 is present in the interior of the vehicle.

The alarm control device 10 is electrically connected to the camera 14. The camera 14 can image the surroundings of the vehicle. The alarm control device 10 can acquire an image of the surroundings of the vehicle captured by using the camera 14 by acquiring an image signal from the camera 14. For example, the camera 14 is provided in the interior of the vehicle. That is, the peripheral image is an image through the window of the door 12.

Processing executed by the alarm control device when the door is locked or unlocked.

Processing executed by the alarm control device 10 when the door 12 is locked or unlocked will be described.

First, processing when the door 12 is locked and unlocked using the authenticated key 13 will be described.

The alarm control device 10 shifts the alarm device 11 to the valid state when the door 12 is locked using the authenticated key 13. For example, the alarm control device 10 determines whether or not the door 12 is locked using the authenticated key 13 based on the lock signal. The alarm control device 10 shifts the alarm device 11 to the invalid state when the door 12 is unlocked using the authenticated key 13. For example, the alarm control device 10 determines whether or not the door 12 is unlocked using the authenticated key 13 based on the lock signal.

Processing when the door 12 is locked and unlocked without using the authenticated key 13 will be described.

The alarm control device 10 does not shift the alarm device 11 to the valid state when the door 12 is locked without using the authenticated key 13. The door 12 can be locked without using the authenticated key 13 by operating the locking and unlocking switch of the door 12. When the door 12 is unlocked without using the authenticated key 13, the alarm control device 10 does not activate the alarm when the alarm device 11 is in an invalid state.

An unlocking alarm control process executed when the alarm device 11 is in the valid state when the door 12 is unlocked without using the authenticated key 13 will be described.

As illustrated in FIG. 2, in the unlocking time alarm control process, the alarm control device 10 determines whether or not there is an authenticated key 13 in the interior of the vehicle (S10). For example, the alarm control device 10 determines that the authenticated key 13 is present in the interior of the vehicle when the periodic signal from the authenticated key 13 is acquired.

When the authenticated key 13 is present in the interior of the vehicle (S10: YES), the alarm control device 10 executes the unlocking-method determination process. The unlocking method determination process is a process for determining whether the door 12 has been unlocked from the interior of the vehicle or from the exterior of the vehicle.

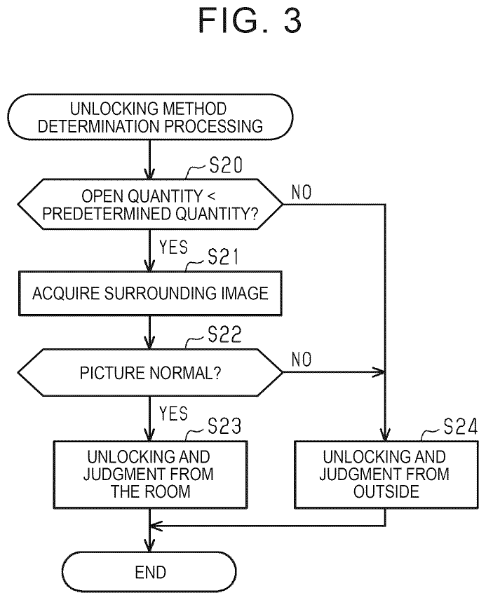

As illustrated in FIG. 3, in the unlocking-method determination process, the alarm control device 10 determines whether or not the opening amount of the windows of the doors 12 is less than the predetermined amount based on the opening amount signal (S20). The alarm control device 10 determines that the opening amount of the window of the door 12 is less than the predetermined amount when the window of the door 12 is not opened. On the other hand, when the window of the door 12 is opened, the alarm control device 10 determines that the opening amount of the window of the door 12 is not less than the predetermined amount. For example, the predetermined amount may be an opening amount into which an instrument for operating the locking and unlocking switch of the door 12 can be inserted from the outside of the vehicle. Locking and unlocking the door 12 by inserting the tool from the outside of the vehicle and operating the locking and unlocking switch from the outside of the vehicle is not the locking and unlocking of the door 12 by a regular method.

When the opening amount of the windows of the door 12 is less than the predetermined amount (S20: YES), the alarm control device 10 acquires peripheral images of the vehicles captured by using the camera 14 (S21). The alarm control device 10 determines whether or not the surrounding images are normal (S22). For example, the alarm control device 10 determines whether or not the surrounding image is normal using a learned image recognition model that has been previously machine-learned. The alarm control device 10 determines, based on the image recognition model, whether or not the door 12 has been unlocked regardless of the normal method from the surrounding image. Then, based on the determination result, it is determined whether or not the surrounding image is normal. For example, the alarm control device 10 determines that the surrounding image is not normal when it is determined that the door 12 is unlocked from the outside of the vehicle based on the surrounding image.

When the surrounding images are normal (S22: YES), the alarm control device 10 determines that the door 12 is unlocked from the interior of the vehicle, and ends the unlocking-method determination process. On the other hand, when the opening amount of the window of the door 12 is equal to or greater than the predetermined amount (S20: NO) or when the surrounding images are not normal (S22: NO), the alarm control device 10 determines that the door 12 is unlocked from the outside of the vehicle, and ends the unlocking-method determination process.

Returning to the explanation of the unlocking-time alarm control process, as shown in FIG. 2, the alarm control device 10 determines whether or not the door 12 is unlocked from the interior of the vehicle as a result of the unlocking-method determination process (S12). When it is determined that the door 12 is unlocked from the interior of the vehicle (S12: YES), the alarm control device 10 shifts the alarm device 11 to the disabled state. On the other hand, when the authenticated key 13 is not present in the interior of the vehicle (S10: NO), and when it is determined that the door 12 is unlocked from the exterior of the vehicle (S12: NO), the alarm control device 10 causes the alarm device 11 to activate an alarm.

### Operations of Present Embodiment

The operation of the present embodiment will be described.

The alarm control device 10 shifts the alarm device 11 to the valid state when the door 12 is locked by using the authenticated key 13. Further, the alarm control device 10 shifts the alarm device 11 to the invalid state when the door 12 is unlocked by using the authenticated key 13. The alarm control device 10 activates the alarm device 11 when the alarm device 11 is in a valid state and the door 12 is unlocked without using the authenticated key 13 in a state (S10: NO) in which the authenticated key 13 is not in the interior of the vehicle (S14). In addition, in the alarm control device 10, there is a case in which the alarm device 11 is in the valid state and the authenticated key 13 is in the interior of the vehicle (S10: YES), and the door 12 is unlocked from the outside of the vehicle without using the authenticated key 13 (S12: NO). In this instance, the alarm device 11 is activated (S14).

On the other hand, in the alarm control device 10, when the alarm device 11 is in the valid state and the authenticated key 13 is in the interior of the vehicle (S10: YES), the door 12 is unlocked from the interior of the vehicle (S12: YES). In this case, the alarm device 11 is switched to the disabled state (S13). That is, the alarm control device 10 does not activate the alarm device 11 when the door 12 is unlocked from the inside of the vehicle in a state (S10: YES) in which the alarm device 11 is in the valid state and the authenticated key 13 is in the inside of the vehicle (S12: YES).

When the door 12 is unlocked while the window of the vehicle is opened by a predetermined amount or more (S20: NO), the alarm control device 10 determines that the door 12 is unlocked from the outside of the vehicle without using the authenticated key 13 (S24). When the door 12 is unlocked, the alarm control device 10 acquires images of the surroundings of the vehicle (S21). Based on the images, the alarm control device 10 determines whether or not the door 12 is unlocked without using the authenticated key 13 from the outside of the vehicle (S22).

### Effects of Present Embodiment

The effects of the present embodiment will be described.

(1) By locking the door 12 using the authenticated key 13, after the alarm device 11 is activated, if the door 12 is unlocked from the interior of the vehicle without the authenticated key 13 in the presence of the authenticated key 13 in the interior of the vehicle, the alarm is not activated. For example, when the user takes a nap in the interior of the vehicle, it is conceivable to lock the door 12 for security. Further, for security, it is conceivable to enable the alarm device 11 by locking the door 12 using the authenticated key 13. In such a situation, when the user unlocks the door 12 by operating the locking/unlocking switch of the door 12, the user does not feel troublesomeness by not operating the alarm to the alarm device 11. That is, the alarm can be activated suitably.

(2) On the other hand, when the door 12 is unlocked from the outside of the vehicle even in a state where the authenticated key 13 is present in the interior of the vehicle, an alarm is activated to the alarm device 11. For example, in the above-described situation, when the door 12 is unlocked from the outside of the vehicle, the security can be improved by activating an alarm to the alarm device 11. That is, the alarm can be activated suitably.

(3) For example, when the window of the door 12 is opened by a predetermined amount or more, the locking/unlocking switch of the door 12 can be operated by inserting an instrument or a hand through the opening. Therefore, in such a situation, it is determined that the door 12 is unlocked without using the authenticated key 13 from the outside of the vehicle, and the alarm is activated to the alarm device 11, whereby the security can be improved. That is, the alarm can be activated suitably.

(4) For example, when an attempt is made to unlock the door 12 from the outside of the vehicle without using the authenticated key 13, the situation is included in an image obtained by capturing the surroundings of the vehicle. Therefore, in a case where the door 12 is unlocked, it is determined whether or not the door 12 is unlocked from the outside of the vehicle without using the authenticated key 13 based on the image, whereby the security can be improved while suppressing the user from feeling troublesomeness. That is, the alarm can be activated suitably.

### Modifications

The above embodiment may be modified as follows. Note that the above-described embodiments and the following examples may be combined with each other within a range not technically inconsistent with each other.
The alarm control device 10 may determine that the door 12 is unlocked from the interior of the vehicle when the door 12 is unlocked without using the authenticated key 13 while the authenticated key 13 is in the interior of the vehicle. That is, the alarm control device 10 may not activate the alarm device 11 when the door 12 is unlocked without using the authenticated key 13 while the authenticated key 13 is in the interior of the vehicle. According to this, it is possible to suppress the control of the alarm control device 10 becoming complicated.
The alarm control device 10 may execute S21 process without executing S20 process in the unlocking process determination process. In other words, the alarm control device 10 does not need to determine whether or not the door 12 is unlocked from the interior of the vehicle based on the opening amount of the window of the door 12. According to this, it is possible to suppress the control of the alarm control device 10 becoming complicated.
The alarm control device 10 may execute S23 process without executing S22 process in the unlocking process determination process. In other words, the alarm control device 10 does not need to determine whether or not the door 12 is unlocked from the interior of the vehicle based on the peripheral image of the vehicle. According to this, it is possible to suppress the control of the alarm control device 10 becoming complicated.
The alarm control device 10 may be capable of determining that the door 12 is unlocked from the outside of the vehicle by a method in addition to or instead of the method described in the above embodiment.
The alarm control device 10 may terminate the unlocking alarm control process without executing S13 process in the unlocking alarm control process. In other words, even when the door 12 is unlocked by a regular method, the alarm control device 10 may not activate the alarm while maintaining the alarm device 11 in the valid state when it is performed without using the authenticated key 13. For example, in a situation where the user takes a nap in the interior of the vehicle, the alarm is not activated for a certain period of time after the user temporarily unlocks the door 12. In this case, the alarm device 11 is activated after a predetermined period of time has elapsed, so that the security can be improved. That is, the alarm can be activated suitably.
The door 12 may be locked and unlocked using a different authenticated key than the authenticated key 13. For example, the authenticated key different from the authenticated key 13 is a spare key different in ID from the authenticated key 13. In this case, the alarm control device 10 shifts the alarm device 11 to the valid state when the door 12 is locked by using the spare key. In addition, the alarm control device 10 shifts the alarm device 11 to the invalid state when the door 12 is unlocked by using the spare key. For example, the alarm control device 10 may make an affirmative determination when at least one of the authenticated key 13 and the spare key is in the interior of the vehicle in S10 of the unlocking alarm control process. For example, the alarm control device 10 may make an affirmative determination when, in S10 of the unlocking alarm control process, the key used to shift the alarm device 11 to the valid status among the authenticated key 13 and the spare key is in the interior of the vehicle. In this case, the alarm control device 10 may make an affirmative determination even when the door 12 is unlocked by a key that differs from the key used when the alarm device 11 is shifted to the valid state S12 the unlocking alarm control process.

What is claimed is:

1. An alarm control device that controls an alarm device that activates an alarm when a door of a vehicle is unlocked, the alarm control device controlling the alarm device so as to shift to an activated state when the door is locked using an authenticated key, and so as to shift to an inactivated state when the door is unlocked using the authenticated key, wherein the alarm device is not caused to issue an alarm when the door is unlocked from an inside of a cabin of the vehicle without using the authenticated key in a state in which the alarm device is in the activated state and the authenticated key is in the inside of the cabin of the vehicle.

2. The alarm control device according to claim 1, wherein the alarm device is caused to issue an alarm when the door is unlocked from an outside of the cabin of the vehicle without using the authenticated key when the alarm device is in the activated state.

3. The alarm control device according to claim 2, wherein it is determined that the door is unlocked from the outside of the cabin of the vehicle without using the authenticated key when the door is unlocked in a state in which a window of the vehicle is opened by a predetermined amount or more.

4. The alarm control device according to claim 2, wherein:
an image that captures surroundings of the vehicle is acquired when the door is unlocked; and
it is determined based on the image whether the door is unlocked from the outside of the cabin of the vehicle without using the authenticated key.
